(19) United States
(12) Patent Application Publication
(10) Pub. No.: US 2005/0121374 A1
(43) Pub. Date: Jun. 9, 2005

(54) Device for bleeding the separated water from a fuel filter

(76) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(21) Appl. No.: 10/502,322

(22) PCT Filed: Jan. 31, 2003
(86) PCT No.: PCT/EP03/00986

(30) Foreign Application Priority Data
Feb. 4, 2002 (IT) RE2002A000013

(51) Int. Cl. B01D 21/24

(52) U.S. Cl. 210/97

(57) ABSTRACT

The device is applicable to a vehicle which comprises: a fuel filter (3) having a filtering means (31) for filtering the fuel entering the filter (3) and for separating the water present therein, and a collection chamber (32) for the separated water; a fuel reservoir (2) having a capacity adequate for the vehicle circulation; means (52) for transferring fuel from that region of the filter (3) lying downstream of the filtering means (31) to the engine feed means (5); means (41,42) for feeding fuel from the resevoir (2) to the inlet (34a) of the filter (3) at a greater rate than the maximun flow rate transferred from the filter (3) to he feed means (5). The device comprises a second collection chamber (15) for the separated water and second means (20, 21) for tranferring liquid from the first collection chamber (32) to the second collection chamber (15) at the residual flow rate between that entering the filter (3) and that tranferred to the feed means (5).

### TECHNICAL FIELD

This invention concerns the bleeding of the separated water from a fuel filter on vehicles with an internal combustion engine, in particular with a diesel engine.

The invention relates to vehicles comprising:
a fuel filter having a filtering means for filtering the fuel entering the filter and for separating the water present therein, and a collection chamber for the separated water,
a fuel tank having a capacity adequate for the extent of vehicle travel,
means for transferring fuel from that region of the filter lying downstream of the filtering means to the engine feed means,
means for feeding fuel from the tank to the filter inlet at a greater rate than the maximum flow rate transferred from the filter to the feed means.

### BACKGROUND ART

The current trend among motor vehicle manufacturers is to equip the vehicle with fuel filters (for diesel oil in particular) having an increasingly longer life and greater filtering efficiency.

Modern diesel oil filters, in particular if installed on vehicles with diesel engine direct injection feed means of common rail or injector with pump type must ensure high filtering efficiency, a long life and a high degree of separation of the water present in the fuel.

The increased performance of such engines has resulted in ever more complex, mechanically precise and hence costly fuel feed systems; the relative mechanical components are therefore protected against wear and against corrosion by a fuel filter, which in particular separates the water which could otherwise result in damaging oxidation of the mechanical parts with which it comes into contact, and collects it in a suitable collection chamber.

In vehicles of more recent design, the diesel oil filter is of the type with an immersion cartridge housed in a container (of plastic material), the lower portion of which defines the collection chamber for the separated water.

The fuels currently supplied to the distributor network contain nominally about 0.02% of water but it is often possible, because of water infiltration into storage tanks or of condensation of moist air within the vehicle tank, for a considerable water quantity to be accumulated within the vehicle tank itself.

Common rail systems are provided with a pump immersed in the tank and operating at a rate of approximately 160 I/h; consequently in about 30 minutes all the liquid present in the tank is recirculated at least once through the system, to hence pass through the filter.

One of the modern characteristics of filter cartridges is their high power of separating water from the diesel oil (of the order of 99%), there hence being the risk that the filter rapidly accumulates such a water quantity as to exceed the containing capacity of the appropriate collecting chamber present in the filter. Exceeding the accumulation capacity of this chamber means that the filter cartridge operates immersed in water, hence obstructing the pores and in the long term completely filling the filter with water which is drawn towards the user device (high pressure pump). If this should happen the pump and the diesel oil injectors almost immediately seize, with prohibitively disastrous and costly consequences in terms of their renewal.

To avoid these dangers it is known to use a sensor for sensing the water level in the filter collection chamber, which however always presupposes timely direct manual intervention on the filter by the driver, who in reality is not always able to carry out the operations involved in bleeding the water from the filter, and often prefers to await the first available opportunity or the next ordinary service check on the vehicle.

An object of this invention is to prevent an excessive and dangerous water quantity being able to accumulate in the water collection chamber of the filter, without any intervention by the driver other than after such a distance as to require usual more general servicing, as defined by the normal vehicle servicing specification, with the advantage that the driver can leave water removal to the usual service station during normal vehicle servicing.

### DISCLOSURE OF THE INVENTION

This and other objects are attained by the device of the invention as characterised in the claims.

The invention is described in detail hereinafter with the aid of the accompanying figures which illustrate one embodiment thereof by way of non-limiting example.

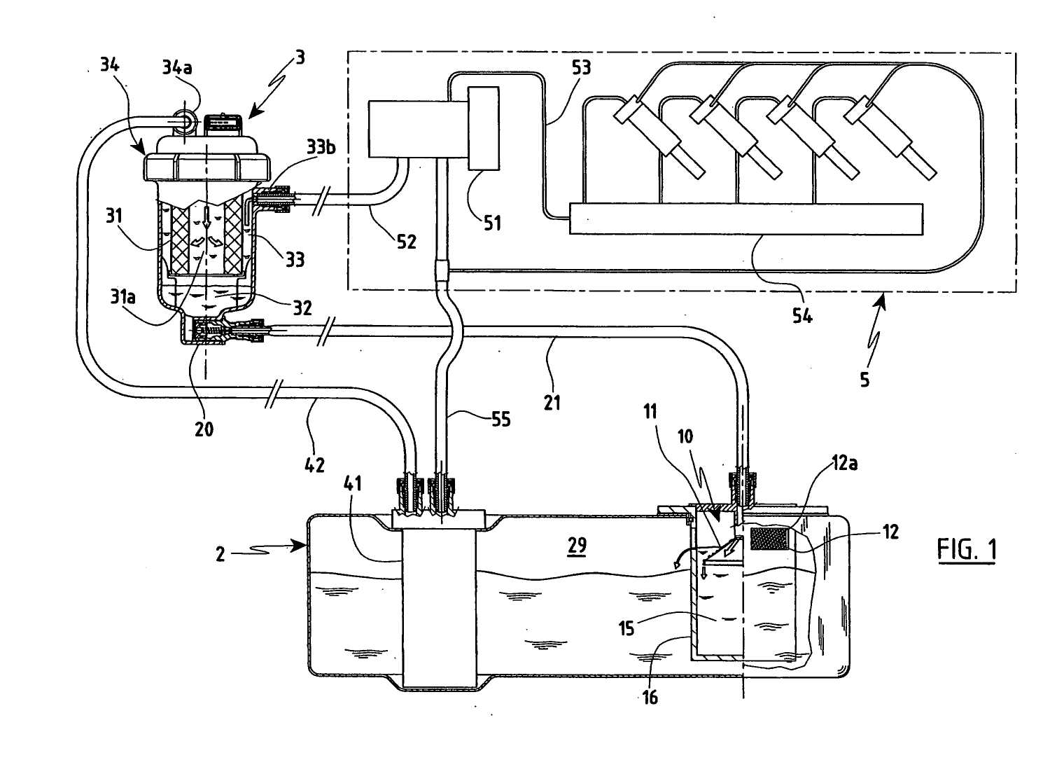

FIG. 1 is a schematic overall view of the device of the invention, applied to a fuel filter and tank of a vehicle.

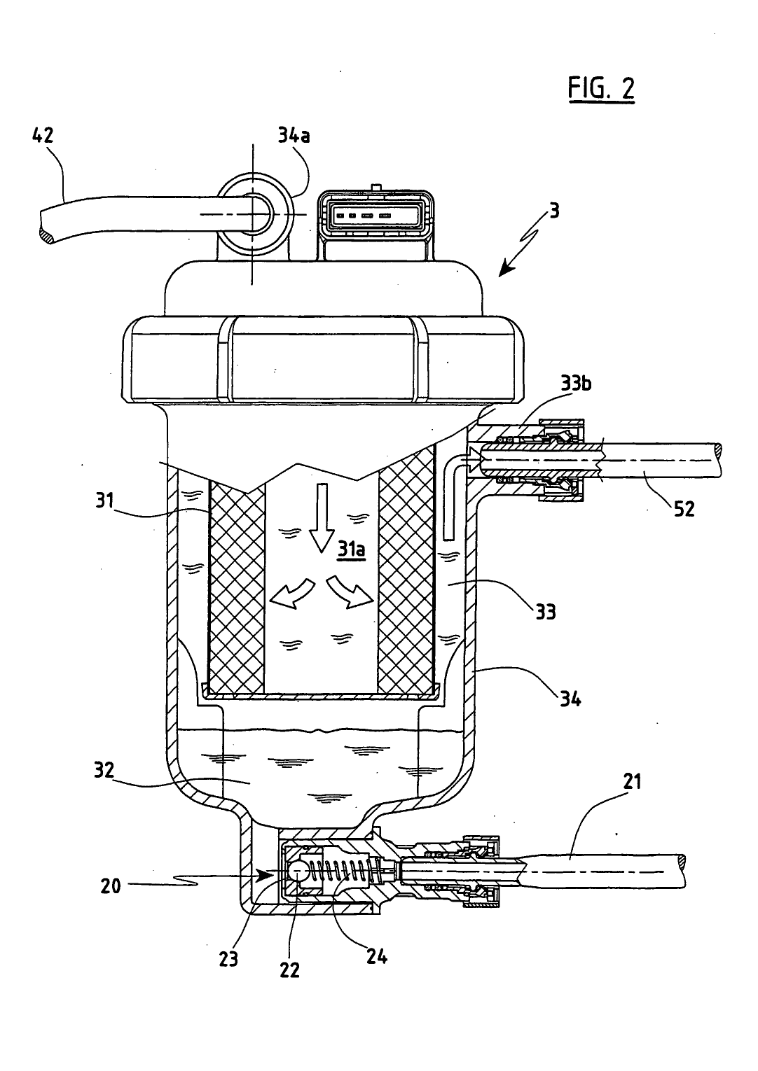

FIG. 2 is an enlarged detail of FIG. 1, relating to the fuel filter.

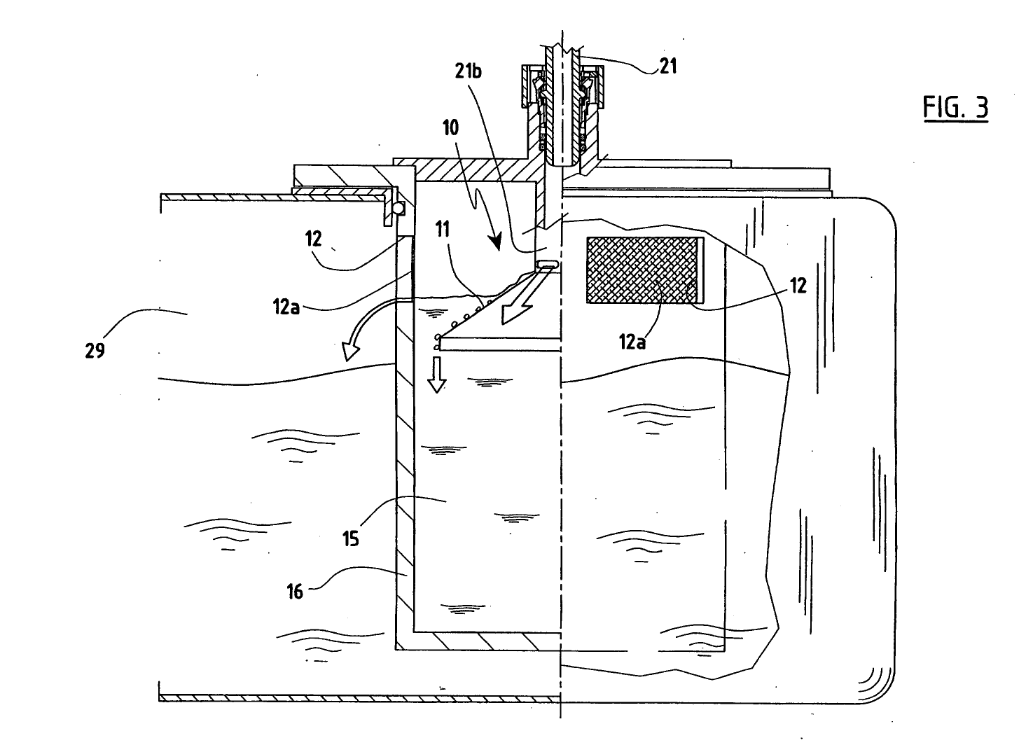

FIG. 3 is an enlarged detail of FIG. 1, relating to the second means for separating water from the fuel.

FIG. 1 shows a traditional circuit for feeding fuel from the tank to the engine of a vehicle.

This circuit comprises:
a tank 2 for the fuel fed to the vehicle,
a fuel filter 3 having a filtering means 31 for filtering the fuel entering the filter 3 and for separating the water present therein, and also having a separated water collection chamber positioned downstream of the filtering means 31,
means for transferring fuel from the that region 33 of the filter 3 lying downstream of the filtering means 31 to the engine feed means 5, and
means for feeding fuel from the tank 2 to the inlet of the filter 3 at a greater rate than the maximum flow rate transferred from the filter 3 to the feed means 5, and specifically comprising a low pressure (1-20 bar) pump 41 applied to the tank and a fuel conduit 42 which feeds fuel from the pump 41 to the inlet of the filter 3.

In the embodiment shown in FIG. 1, the engine feed means 5 comprises a high pressure pump 51 connected at its inlet to a conduit 52, the entry of which is applied to the downstream region 33 of the filter 3, and the delivery 53 of which feeds an injection device 54 for the engine (of known type and illustrated only schematically in the figures). The illustrated type of feed means 54 operates by withdrawing at its inlet a fuel flow rate far in excess of that fed to the engine; consequently the pump 51 then discharges the residual part of the fuel to the tank 2 through a conduit 55. However the invention is equally applicable to circuits in which the pump 51 does not comprise a return conduit 55 to the tank.

The illustrated filter 3 comprises an outer casing 34, the central part of which houses the filtering means 31 of the vertical cylindrical toroidal cartridge type defining in its interior a closed chamber 31a coaxial with the casing 34. This possesses an inlet 34a connected to the conduit 42 to feed the flow into the inner chamber 31a.

Beyond the filtering means 31, the casing defines an outer annular chamber 33 defining said region lying downstream of the filtering means. Below said chamber 33, the casing 34 defines, under the filtering means 31, said water collection chamber 32 which communicates freely and amply with the overlying annular chamber 33.

The filtering means 31 is able to both filter the fuel from solid or semi-solid parts, and to aggregate the water particles present therein to cause them to enlarge and then fall into the chamber 32.

At the top of the chamber 33 there is an outlet 33b to which the conduit 52 feeding the pump 51 is connected.

According to the invention, there are provided second means 10 for separating the water from the fuel, disposed in a position separated from and external to the fuel filter 3 and releasing the treated fuel to the tank 2, and a second chamber 15 for collecting the water separated by the means 10.

Said second collection chamber 15 is defined by a receptacle 16 incorporated into the interior of the fuel tank 2 and has a capacity many times greater than the first collection chamber 32, to the extent of containing a water quantity at least equal to that separated from the fuel during a travel distance of such length as to require on termination a more general servicing of the vehicle at a service station.

In the embodiment shown in the figures, the second water separation means 10 comprise a downwardly inclined frusto-conical surface 11 along which the liquid is made to run, and which lies above the second collection chamber 15. In addition, in the upper part of the receptacle 16a series of passages 12 is provided for fuel passage from the top of the chamber 15 to the inner chamber 29 of the tank 2, they being provided with filtering means 12a for retaining water. The invention also comprises second means for transferring liquid from the base of the first collection chamber 32 to the water separation means 10 at the residual flow rate between that which enters the filter 3 and that transferred to the feed means 5. This residual flow rate has a value greater than the possible rate at which the separated water can accumulate in the first collection chamber 32.

Said second transfer means comprise a valve 20 positioned at the base of the first collection chamber 32, to hinder the passage of liquid in such a manner as to reduce the flow rate passing through it to an extent compatible with the required fuel transfer from the filter 3 to the feed means 5. To the exit of the valve 20 there is then connected a conduit 21, the final end 21b of which feeds the liquid onto the highest portion of the frusto-conical surface 11.

The device of the invention operates in the following manner. During vehicle operation, the pump 41 feeds a continuous flow of fuel from the tank to the inlet 34a of the filter 3, to enter the internal chamber 31a and from there to pass through the filtering means 31 to the outer chamber 33. In passing through the filtering means 31, the fuel is filtered and in addition the water particles present therein aggregate to halt on the outer surface of the filtering means 31. Moreover, as the water is of greater density than the fuel (diesel oil), said aggregated particles descend along the outer surface of the means 31 and into the underlying collection chamber 32.

A part of the liquid reaching the filter 3 is transferred to the pump 51 of the feed means 5 via the conduit 52, in such a quantity as to satisfy the requirements of the engine. This withdrawn part is the most purified part of the fuel.

The residual liquid part which reaches the filter 3 is withdrawn from the collection chamber 32 and transferred to the second separation means 10. The rate of this withdrawal is programmed at a greater value than the maximum water quantity that can accumulate in the chamber 32. Consequently the water in the chamber 32 can never exceed the maximum safety level for the chamber itself, hence avoiding any risk deriving from the fact that the filtering means 31 may work even partially immersed in the water.

The valve 20 serves to create an obstacle to liquid passage such that the liquid present in the filter 3 downstream of the filtering means 31 is distributed to the pump 51 and to the second separation means 10 at the scheduled flow rates.

In the embodiment shown in the figures, the valve 20 comprises a valving member 22 urged by a spring 24 to close a passage 23. When the pressure in the chamber 32 exceeds the value of the spring 24, the liquid passes through the passage 23.

This valve is preferred when a relatively high flow rate (50-200 litres/hour) is transferred through the conduit 42.

In other cases, for example for relatively low flow rates (2-5 litres/hour), a valve 20 of cheaper construction, such as a simple constriction for the fluid, can be provided.

The liquid leaving the chamber 32 comprises separated water present in the chamber plus a fuel part. These two parts are again separated by the second means 10, when the flow is released onto the inclined surface 11 which, by slowing the flow down, causes the water molecules (already aggregated into droplets by the filtering means 31) to combine and precipitate onto the base of the collection chamber 15. In this respect the water molecules are denser than the diesel oil molecules and consequently tend to precipitate towards the base of the chamber 15.

While the water collects on the base of the chamber 15, the fuel remains in the upper part of the said chamber and overflows towards the inner chamber 29 of the tank 2 through the passages 12.

By suitably dimensioning the collection chamber 15, on the basis of a statistical estimate of the probability of finding determined quantities of water in the diesel oil supplied to the distributor network, the vehicle user does not have to worry about monitoring the warning light on the instrument panel indicating water presence in the filter 3. In this respect, the chamber 15 can be sized for such a volume as to enable container emptying to be carried out by the service station during routine servicing.

For greater safety, known alarm devices could obviously also be associated with the filter 3 to monitor the level of water which accumulates in the chamber 32.

Numerous modifications of a practical and applicational nature can be made to the invention but without leaving the scope of the inventive idea as claimed below.

1. A device for bleeding the separated water from a fuel filter on vehicles with an internal combustion engine, in particular with a diesel engine, the vehicle comprising:
a fuel filter (3) having a filtering means (31) for filtering the fuel entering the filter (3) and for separating the water present therein, and a collection chamber (32) for the separated water;
a fuel tank (2) having a capacity adequate for the extent of vehicle travel;
means (52) for transferring fuel from that region of the filter (3) lying downstream of the filtering means (31) to the engine feed means (5);
means (41, 42) for feeding fuel from the tank (2) to the inlet (34a) of the filter (3) at a greater rate than the maximum flow rate transferred from the filter (3) to the feed means (5);
characterised by comprising:
a second collection chamber (15) for the separated water;
second means (20, 21) for transferring liquid from the first collection chamber (32) to the second collection chamber (15) at the residual flow rate between that entering the filter (3) and that transferred to the feed means (5);
said residual flow rate having a value greater than the rate at which the separated water accumulates in the first collection chamber (32).

2. A circuit as claimed in claim 1, characterised by comprising second means (10) for separating the water from the fuel, these being disposed in a position separated from and external to the fuel filter (3), to release the treated fuel to the fuel tank (2); said second liquid transfer means (20, 21) feeding the second water separation means (10).

3. A circuit as claimed in claim 2, characterised in that said second collection chamber (15) is incorporated into the fuel tank (2) and has a capacity many times greater than the first collection chamber (32).

4. A circuit as claimed in claim 3, characterised in that the second water separation means (10) comprise a downwardly inclined surface (11) along which the liquid is made to slide and which lies above the second collection chamber (15), and further comprise a passage (12) extending between the upper part of the second chamber (15) and the inner chamber of the tank 2, and provided with filtering means (12a) for retaining water.

5. A circuit as claimed in claim 2, characterised in that said second transfer means (20, 21) comprise a valve (20) positioned at the exit of the first collection chamber (32), to create an obstacle to the passage of liquid in such a manner as to reduce the exit flow rate to an extent compatible with the required fuel transfer from the filter 3 to the feed means (5).
